(19) United States
(12) Patent Application Publication
(10) Pub. No.: US 2008/0031099 A1
(43) Pub. Date: Feb. 7, 2008

(54) Optical pickup and optical disc device

(75) Inventor: Kouichi Tezuka, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/904,734

(22) Filed: Sep. 28, 2007

Related U.S. Application Data
(63) Continuation of application No. PCT/JP06/06449, filed on Mar. 29, 2006.

(30) Foreign Application Priority Data
Mar. 30, 2005 (JP) 2005-097338

(51) Int. Cl. G11B 7/00

(52) U.S. Cl. 369/44.14

(57) ABSTRACT

An optical pickup, provided with a first objective lens and a second objective lens, includes a first light source and a polarizing beam splitter, where the first light source emits a laser beam of a predetermined wavelength, and the polarizing beam splitter causes a first polarized beam having a predetermined polarization characteristic to be reflected toward the first objective lens and transmits a second polarized beam having a different polarization characteristic so that the second beam is led to the second objective lens. A polarization control element is provided between the first light source and the polarizing beam splitter to convert the laser beam emitted by the first light source into the above-mentioned first and second polarized beams.

This is a Continuation under 35 U.S.C. § 111(a) of International Application No. PCT/JP2006/306449, filed Mar. 29, 2006.

### TECHNICAL FIELD

The present invention relates to an optical disc device that performs recording/reproduction with respect to an optical disc, and in particular to an optical pickup constituting an essential component of the optical disc device. More specifically, the present invention relates to an optical pickup including a plurality of objective lenses to thereby enable recording/reproducing with respect to a plurality of types of optical discs of different standards.

### BACKGROUND ART

Various structures have been proposed for the optical disc device that performs recording/reproduction of the plurality of types of optical discs of different standards. Because of the development of high-density recording media such as a blueray disc and HD-DVD in particular, the optical disc device compatible with the blue beam optical disc (Blu-ray Disc and HD-DVD) in addition to the conventional red beam optical disc (DVD) or near infrared beam optical disc (CD) is being sought for.

The optical pickup for such type of optical disc device has to be compatible with a wavelength of a laser beam applied to the optical discs of different standards and the cover layer thickness from the disc surface to the recording layer. In the case of the CD for example, the cover layer thickness is 1.2 mm, and the laser beam wavelength applied thereto is generally 780 nm. Referring to the DVD, the cover layer thickness is 0.6 mm, and the laser beam wavelength applied thereto is generally 660 nm.

To support the plurality of types of optical discs specified by different cover layer thicknesses and wavelengths as above with a single optical pickup, structures based on various techniques have been proposed so far, for example the one disclosed in the patent document 1. The technique according to the patent document 1 employs a bifocal lens with a diffraction grating, having concentric grooves formed on its surface, as an objective lens mounted on the optical pickup. When laser beams of different wavelengths are transmitted through the bifocal lens, focal points are adjusted at appropriate points according to the wavelength of the laser beam and the cover layer thickness (spherical aberration is corrected according to the cover layer thickness), because the diffraction angles are different. Thus, the technique allows employing a single optical pickup for recording/reproduction of both of the CD and the DVD, by effectively utilizing the difference in laser beam wavelength and in cover layer thickness.

Referring to the Blu-ray Disc and the HD-DVD, on the other hand, the cover layer thickness of the Blu-ray Disc is 0.1 mm and that of the HD-DVD is 0.6 mm. Despite of the difference in cover layer thickness, the wavelength of the laser beam to be applied to the Blu-ray Disc and the HD-DVD is the same, specifically generally 405 nm. In such a case, the bifocal lens with the diffraction grating cannot be compatible to both of the Blu-ray Disc and the HD-DVD. From the objective viewpoint of lens manufacturing technique, it is quite difficult to design a single objective lens compatible with the both discs, and upon taking the balance among cost, outer dimensions and performance into consideration, it is preferable at present to employ the objective lenses designed for each of the Blu-ray Disc and the HD-DVD.

Accordingly, a structure similar to the one disclosed in, for example, the patent document 2 has been proposed. In this structure, as shown in FIG. 19(A) for example, an optical pickup 81 including an objective lens and a light source for the HD-DVD and another optical pickup 82 including an objective lens and a light source for the Blu-ray Disc are provided for an optical disc device 80. These optical pickups 81, 82 are mounted so as to move radially of the disc 84, independently from each other.

The objective lens for the HD-DVD and that for the Blu-ray Disc may both be employed as the objective lens for the CD and the DVD. Accordingly, one of the optical pickups 81, 82 may be used for the CD/DVD/HD-DVD and the other for the Blu-ray Disc, or one for the CD/DVD/Blu-ray Disc and the other for the HD-DVD.

The structure shown in FIG. 19(A) requires two sets of mechanisms that drive the respective optical pickups 81, 82, and therefore an improved structure shown in FIG. 19(B) has been proposed. This structure includes a single optical pickup 86 for an optical disc device 85. The optical pickup 86 includes a light source 87 for the Blu-ray Disc and a light source 88 for the HD-DVD disposed so as to oppose each other, and an objective lens 89 for the Blu-ray Disc and an objective lens 90 for the HD-DVD aligned side by side circumferentially of the disc 84, at a central portion of the optical pickup 86. Such structure only requires one set of mechanism that drives the optical pickup 86 radially of the disc 84, thus resulting in a simplified structure.

FIG. 20 depicts details of the optical component employed in the optical pickup 86 shown in FIG. 19(B). The optical pickup 86 includes, as a first optical system 86′, the blue laser diode 87 used as the light source for the Blu-ray Disc, the objective lens 89 for the Blu-ray Disc, collimator lenses 91, 94, a half mirror 92, an upward reflection mirror 93, and a photodetector 95 for the Blu-ray Disc. The optical pickup 86 also includes, as a second optical system 86″, the blue laser diode 88 used as the light source for the HD-DVD, the objective lens 90 used in common for the HD-DVD and the CD/DVD, collimator lenses 96, 99, a half mirror 97, an upward reflection mirror 98, a photodetector 100 for the HD-DVD, an optical unit 101 containing therein a photodetector and a light source for the CD/DVD, and a dichroic mirror 102.

Patent document 1: JP-A-H08-315402

Patent document 2: JP-A-2003-109357

In the structure as shown in FIGS. 19(B) and 20, however, the optical system for the Blu-ray Disc and the optical system for the HD-DVD are separated from each other, and the optical components of the same optical characteristics, for example the blue laser diode used as the light source, have to be respectively provided for the optical system for the Blu-ray Disc and that for the HD-DVD. In particular, since the blue laser diode is more expensive than the red laser diode used for the CD/DVD and the like, the component cost is prone to considerably increase. This naturally leads to an increase in cost of the device as a whole, thus degrading the cost performance.

For example, the two optical systems for the Blu-ray Disc and the HD-DVD have to be mounted on a single optical pickup, which leads to larger dimensions and heavier weight of the optical pickup, and then to slower seek action with respect to the optical disc. Besides, the necessity of driving the large and relatively heavy optical pickup radially of the optical disc may lead to an increase in power consumption.

### DISCLOSURE OF THE INVENTION

The present invention has been proposed under the foregoing situation. An object of the present invention is to provide an optical pickup that has a simplified structure, and that enables the sharing of an optical system including a light source. Another object of the present invention is to provide an optical disc device incorporating such an optical pickup.

To achieve the foregoing objects, the present invention has taken the following technical measures.

According to a first aspect of the present invention, there is provided an optical pickup including a first objective lens and a second objective lens. The optical pickup comprises: a first light source that emits a laser beam of a predetermined wavelength; a polarizing beam splitter that reflects a first polarized beam having a predetermined polarization characteristic to be led to the first objective lens, and that transmits a second polarized beam having a different polarization characteristic to be led to the second objective lens; and a polarization control element located between the first light source and the polarizing beam splitter, to convert the laser beam emitted by the first light source into the first polarized beam and the second polarized beam.

Preferably, the polarizing beam splitter is located immediately under the first objective lens, and the optical pickup includes an upward reflection mirror located immediately under the second objective lens so as to direct the second polarized beam transmitted through the polarizing beam splitter, toward the second objective lens.

Preferably, the optical pickup includes a second light source and a dichroic mirror, where the second light source emits a laser beam different in wavelength from the first light source, and the dichroic mirror reflects one of two laser beams, i.e. the laser beam emitted by the first light source and the laser beam emitted by the second light source, while the other laser beam is allowed to pass through the dichroic mirror. The upward reflection mirror may be a half mirror. The dichroic mirror may be located between the second light source and the upward reflection mirror, or between the polarizing beam splitter and the upward reflection mirror.

Preferably, the laser beam emitted by the first light source to be incident upon the polarizing beam splitter and the laser beam emitted by the second light source to be incident upon the upward reflection mirror are on the same optical axis, but incident from opposite directions.

Preferably, the optical pickup includes an intermediate half mirror, a first photodetector and collimator lenses, where the intermediate half mirror is located between the first light source and the polarization control element, the first photodetector detects, via the intermediate half mirror, the laser beam returning from at least one of the first objective lens and the second objective lens through the polarizing beam splitter and the polarization control element, the collimator lens or lenses are located at two positions, i.e. between the first light source and the intermediate half mirror and between the intermediate half mirror and the first photodetector, or at one position between the intermediate half mirror and the polarization control element.

Preferably, the optical pickup includes a λ/4 plate and a second photodetector, where the λ/4 plate is located between the polarizing beam splitter and the first objective lens, and the second photodetector detects the laser beam that has passed through the λ/4 plate twice in both directions, returning from the first objective lens through the polarizing beam splitter in a different direction from the first photodetector. The first photodetector may detect the laser beam returning from the second objective lens through the upward reflection mirror.

Preferably, the optical pickup includes an intermediate half mirror, a first photodetector and collimator lenses, where the intermediate half mirror is located between the first light source and the polarization control element, the first photodetector detects, via the intermediate half mirror, the laser beam returning from at least one of the first objective lens and the second objective lens through the polarizing beam splitter and the polarization control element, and the collimator lens or lenses are located at two positions between the first light source and the intermediate half mirror and between the intermediate half mirror and the first photodetector, or at one position between the intermediate half mirror and the polarization control element. The λ/4 plate for a specific wavelength band corresponding to the first light source, the dichroic mirror, and a phase correction plate corresponding to the second light source may be sequentially aligned in a direction from the upward reflection mirror to the second light source and in a region therebetween. The upward reflection mirror may be a polarizing half mirror. The dichroic mirror may reflect the laser beam emitted by the first light source and may transmit the laser beam emitted by the second light source.

Preferably, the first photodetector detects the laser beam returning from the first objective lens through the polarizing beam splitter. The upward reflection mirror is a polarizing half mirror. The optical pickup may include the λ/4 plate located between the upward reflection mirror and the second objective lens. A second photodetector may be provided for detecting the laser beam that has passed through the λ/4 plate twice in both directions thereby returning from the second objective lens through the upward reflection mirror in a different direction from the first photodetector.

Preferably, the upward reflection mirror is a polarizing half mirror, while the dichroic mirror reflects the laser beam of the predetermined wavelength emitted by the first light source and transmits the laser beam of the different wavelength emitted by the second light source. The optical pickup includes two λ/4 plates, a first photodetector, two collimator lenses and a second photodetector, where the λ/4 plates are respectively located between the polarizing beam splitter and the first objective lens and between the upward reflection mirror and the second objective lens, the first photodetector detects the laser beam that has passed through the λ/4 plate twice in both directions thereby returning from the first objective lens through the polarizing beam splitter in a different direction from the first light source, two collimator lenses are located between the first light source and the polarizing beam splitter and between the polarizing beam splitter and the first photodetector, and the second photodetector detects the laser beam that has passed through the λ/4 plate twice in both directions thereby returning from the second objective lens through the upward reflection mirror in a different direction from the second light source. The λ/4 plate for the specific wavelength band corresponding to the first light source, the dichroic mirror, and the phase correction plate corresponding to the second light source may be sequentially aligned in a direction from the upward reflection mirror to the second light source and in a region therebetween.

Preferably, the optical pickup includes an intermediate half mirror, a first photodetector and collimator lenses, where the intermediate half mirror is located between the first light source and the polarization control element, the first photodetector detects, via the intermediate half mirror, the laser beam returning from both of the first objective lens and the second objective lens through the polarizing beam splitter and the polarization control element, and the collimator lens or lenses are located at two positions between the first light source and the intermediate half mirror and between the intermediate half mirror and the first photodetector, or at one position between the intermediate half mirror and the polarization control element. The λ/2 plate and the dichroic mirror may be sequentially aligned in a direction from the polarizing beam splitter to the upward reflection mirror and in a region therebetween. The dichroic mirror may transmit the laser beam of the predetermined wavelength emitted by the first light source and may reflect the laser beam of the different wavelength emitted by the second light source.

Preferably, a λ/4 plate is located between the dichroic mirror and the upward reflection mirror.

Preferably, the upward reflection mirror is a polarizing half mirror, and the dichroic mirror is located between the second light source and the upward reflection mirror so as to reflect the laser beam emitted by the first light source and transmit the laser beam emitted by the second light source. The optical pickup may include an intermediate half mirror, a first photodetecotor, and collimator lenses, where the intermediate half mirror is located between the first light source and the polarization control element, the first photodetector detects, via the intermediate half mirror, the laser beam returning from the first objective lens through the polarizing beam splitter and the polarization control element, the collimator lens or lenses are located at two positions between the first light source and the intermediate half mirror and between the intermediate half mirror and the first photodetector, or at one position between the intermediate half mirror and the polarization control element, the λ/4 plate is located between the upward reflection mirror and the second objective lens, and the second photodetector detects the laser beam that has passed through the λ/4 plate twice in both directions thereby returning from the second objective lens through the upward reflection mirror in a different direction from the first light source.

Preferably, one of the first objective lens and the second objective lens is compatible with a Blu-ray Disc, and the other with an HD-DVD.

Preferably, the first light source is a blue laser source for emitting a laser beam of 405 nm as the predetermined wavelength.

Preferably, the second objective lens is compatible with a plurality of types of discs of a standard different from that of the Blu-ray Disc and the HD-DVD.

According to a second aspect of the present invention, there is provided an optical disc device incorporating the optical pickup of the first aspect described above.

### BRIEF DESCRIPTION OF THE DRAWINGS

FIG. 1 is a plan view showing the substantive parts of an optical pickup according to a first embodiment of the present invention;

FIG. 2 is a sectional view taken along the line II-II in FIG. 1;

FIGS. 3(A) and 3(B) are schematic views of the optical pickup shown in FIG. 1;

FIG. 4 is a sectional view showing the substantive parts of an optical pickup according to a second embodiment of the present invention;

FIG. 5 is a sectional view taken along the line V-V in FIG. 4;

FIGS. 6(A) to 6(C) are schematic views of the optical pickup shown in FIG. 4;

FIGS. 7(A) to 7(C) are schematic views showing an optical pickup according to a third embodiment of the present invention;

FIGS. 8(A) to 8(C) are schematic views showing an optical pickup according to a fourth embodiment of the present invention;

FIGS. 9(A) to 9(C) are schematic views showing an optical pickup according to a fifth embodiment of the present invention;

FIGS. 10(A) to 10(C) are schematic views showing an optical pickup according to a sixth embodiment of the present invention;

FIG. 11 is a plan view showing the substantive parts of an optical pickup according to a seventh embodiment of the present invention;

FIGS. 12(A) to 12(C) are schematic views of the optical pickup shown in FIG. 11;

FIGS. 13(A) to 13(C) are schematic views showing an optical pickup according to an eighth embodiment of the present invention;

FIG. 14(A) to 14(C) are schematic views showing an optical pickup according to a ninth embodiment of the present invention;

FIG. 15(A) to 15(C) are schematic views showing an optical pickup according to a tenth embodiment of the present invention;

FIG. 16(A) to 16(C) are schematic views showing an optical pickup according to an eleventh embodiment of the present invention;

FIG. 17(A) to 17(C) are schematic views showing an optical pickup according to a twelfth embodiment of the present invention;

FIG. 18 is a perspective view showing an optical disc device according to the present invention;

FIGS. 19(A) and 19(B) are plan views showing a conventional optical pickup; and

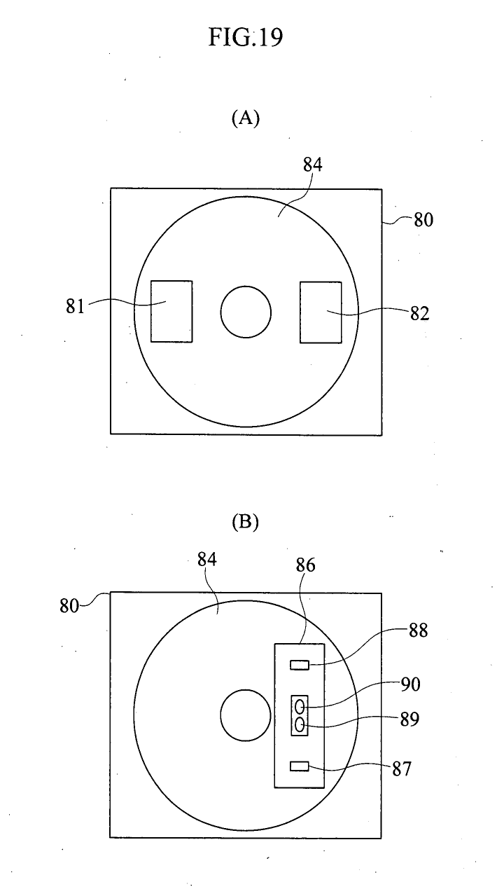

FIG. 20 is a sectional view showing a conventional optical pickup.

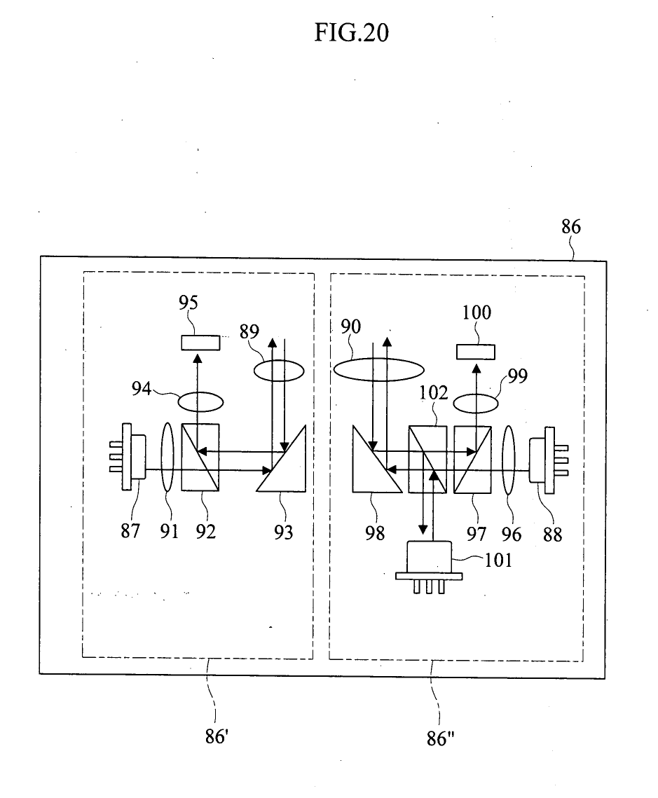

### BEST MODE FOR CARRYING OUT THE INVENTION

### First Embodiment

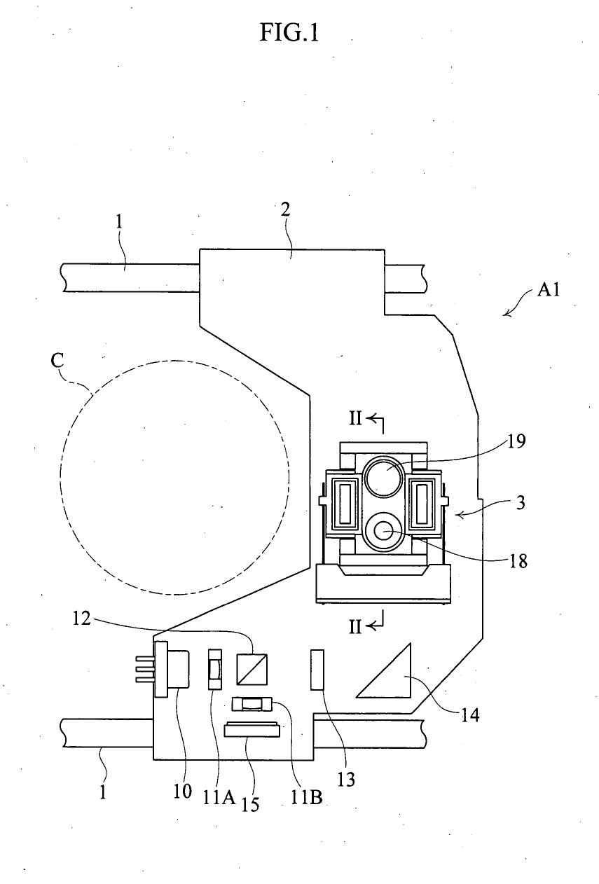

As shown in FIGS. 1 to 3(B), an optical pickup A1 is compatible with both a Blu-ray Disc and a HD-DVD, which are examples of an optical disc. The optical pickup A1 includes, as shown in FIG. 1, a carriage plate 2 set to reciprocate along a pair of guide rails 1 radially of the optical disc (In FIG. 1, the rotational center C of the optical disc is indicated by an imaginary line). On the carriage plate 2, an actuator unit 3, a first light source 10, two collimator lenses 11A, 11B, an intermediate half mirror 12, a polarization control element 13, a fixed mirror 14, and a first photodetector 15 are mounted.

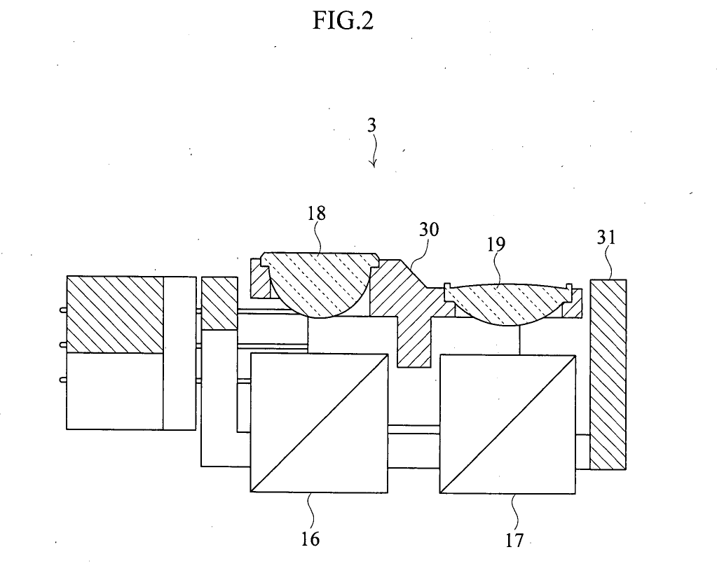

As shown in FIG. 2, the actuator unit 3 includes a movable member 30 supported by a fixing member 31 so as to swing up and down, as well as left and right. The fixing member 31 is of a hollow structure, and includes a polarizing beam splitter 16 and an upward reflection mirror 17 in the hollow space. On the movable member 30, a first objective lens 18 for the Blu-ray Disc and a second objective lens 19 for the HD-DVD are mounted.

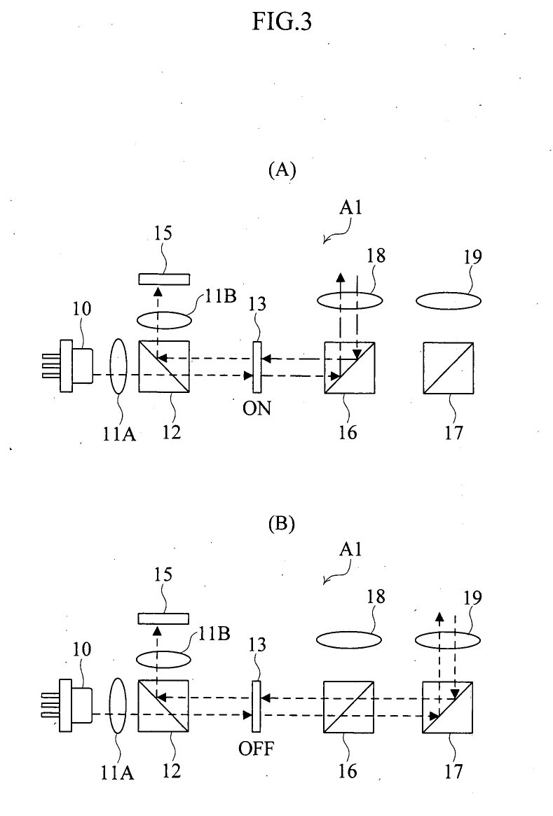

Referring to FIGS. 3(A) and 3(B), optical components constituting an optical system will be described. The first light source 10 is constituted of a blue laser diode for example, and emits a laser beam of a wavelength band of generally 405 nm, which is applicable to both the Blu-ray Disc and the HD-DVD. The first light source 10 emits a P-polarized laser beam having a polarization state parallel to an incident plane. The P-polarized laser beam is indicated by broken lines in FIGS. 3(A) and 3(B).

The collimator lenses 11A, 11B convert the incident laser beam into parallel light, and emit the parallel light. One of the collimator lenses 11A is located between the first light source 10 and the intermediate half mirror 12, and the other collimator lens 11B is located between the intermediate half mirror 12 and the first photodetector 15.

The intermediate half mirror 12 splits the incident laser beam into reflected light and transmitted light. The intermediate half mirror 12 transmits the laser beam emitted by the first light source 10 so as to direct the laser beam toward the polarization control element 13, while reflecting the laser beam returning from the polarization control element 13 thereby directing the laser beam toward the first photodetector 15.

The polarization control element 13 serves to alter the polarization state of the laser beam, for example utilizing a liquid crystal element. For example, when a voltage is applied to the polarization control element 13 to thereby turn on the liquid crystal drive, the incident P-polarized laser beam changes the polarization state into an S-polarized laser beam, which is vertical to the incident plane, while being transmitted. Likewise, when the S-polarized laser beam is incident, the laser beam turns into the P-polarized laser beam, while being transmitted. When the voltage is not applied to the polarization control element 13 and hence the liquid crystal drive is off, the incident P-polarized laser beam is transmitted as it is, without changing the polarization state. The S-polarized laser beam is indicated by dash-dot lines in FIGS. 3(A) and 3(B).

The first photodetector 15 is disposed so as to detect, via the intermediate half mirror 12 and the collimator lens 11B, the laser beam returning through the polarization control element 13, both from the first objective lens 18 and from the second objective lens 19.

The polarizing beam splitter 16 has a characteristic of transmitting or reflecting the laser beam according to its polarization state, and is located immediately under the first objective lens 18. Specifically, the polarizing beam splitter 16 transmits substantially 100% of the P-polarized laser beam, and reflects substantially 100% of the S-polarized laser beam. Thus, as shown in FIG. 3(A), the S-polarized laser beam is reflected by the polarizing beam splitter 16, so as to travel in both directions between the polarization control element 13 and the first objective lens 18. On the other hand as shown in FIG. 3(B), the P-polarized laser beam is transmitted through the polarizing beam splitter 16, to thereby travel in both directions between the polarization control element 13 and the upward reflection mirror 17.

The upward reflection mirror 17 is a total-reflection type mirror, and located immediately under the second objective lens 19. The laser beam incident upon the upward reflection mirror 17 from the polarizing beam splitter 16 is reflected by the upward reflection mirror 17 to proceed to the second objective lens 19, and the laser beam returning from the second objective lens 19 is again reflected by the upward reflection mirror 17, thus to travel toward the polarizing beam splitter 16.

The first objective lens 18 is optimally designed for the Blu-ray Disc, with appropriately corrected spherical aberration in accordance with the cover layer thickness of 0.1 mm of the Blu-ray Disc and the wavelength of generally 405 nm of the laser beam to be applied to the Blu-ray Disc.

The second objective lens 19 is optimally designed for the HD-DVD, with appropriately corrected spherical aberration in accordance with the cover layer thickness of 0.6 mm of the HD-DVD and the wavelength of generally 405 nm of the laser beam to be applied to the HD-DVD.

Referring to FIGS. 3(A) and 3(B), optical effects that take place when the recording/reproduction is performed with respect to the Blu-ray Disc and to the HD-DVD will be described below.

When performing the recording/reproduction with respect to the Blu-ray Disc, as shown in FIG. 3(A) firstly the first light source 10 emits the P-polarized laser beam, which is transmitted through the collimator lens 11A and the intermediate half mirror 12, to be incident upon the polarization control element 13.

At this stage, the polarization control element 13 is in the mode of altering the polarization state, because of a voltage being applied thereto. Accordingly, the P-polarized laser beam incident upon the polarization control element 13 is emitted as the S-polarized laser beam.

The S-polarized laser beam emitted from the polarization control element 13 is incident upon the polarizing beam splitter 16. Since the polarizing beam splitter 16 has the characteristic of reflecting the S-polarized laser beam, the S-polarized laser beam reflected by the polarizing beam splitter 16 illuminates the Blu-ray Disc via the first objective lens 18.

The S-polarized laser beam illuminating the Blu-ray Disc is reflected by the recording layer of the Blu-ray Disc, thus to return to the polarization control element 13 through the first objective lens 18 and the polarizing beam splitter 16.

At this stage also, the polarization control element 13 is in the mode of altering the polarization state because of a voltage being applied thereto, and hence the S-polarized laser beam that has returned to the polarization control element 13 is emitted toward the intermediate half mirror 12 as the P-polarized laser beam.

The P-polarized laser beam which has returned to the intermediate half mirror 12 is thereby reflected, and detected by the first photodetector 15 via the collimator lens 11B. Such arrangement enables precisely making optical access to the Blu-ray Disc.

As shown in FIG. 3(B), in the case of performing the recording/reproduction with respect to the HD-DVD, firstly the first light source 10 emits the P-polarized laser beam, which is transmitted through the collimator lens 11A and the intermediate half mirror 12, to be incident upon the polarization control element 13.

At this stage, the polarization control element 13 is in the mode of transmitting the laser beam without altering the polarization state, without the voltage being applied thereto. Accordingly, the P-polarized laser beam incident upon the polarization control element 13 is emitted as it is, in the form of the P-polarized laser beam.

The P-polarized laser beam emitted from the polarization control element 13 is incident upon the polarizing beam splitter 16. Since the polarizing beam splitter 16 has the characteristic of transmitting the P-polarized laser beam, the P-polarized laser beam transmitted through the polarizing beam splitter 16 is incident upon the upward reflection mirror 17.

At the upward reflection mirror 17, the P-polarized laser beam is reflected toward the second objective lens 19, thus to illuminate the HD-DVD through the second objective lens 19.

The P-polarized laser beam illuminating the HD-DVD is reflected by the recording layer of the HD-DVD, and returns to the polarizing beam splitter 16 through the second objective lens 19 and the upward reflection mirror 17, and is then transmitted through the polarizing beam splitter 16 thus returning to the polarization control element 13.

At this stage also, the polarization control element 13 is in the mode of transmitting the laser beam without altering the polarization state, without the voltage being applied thereto, and hence the P-polarized laser beam which has returned to the polarization control element 13 is transmitted maintaining the form of the P-polarized laser beam, thus reaching the intermediate half mirror 12.

The P-polarized laser beam which has returned to the intermediate half mirror 12 is thereby reflected, and detected by the first photodetector 15 via the collimator lens 11B. Such arrangement enables precisely making optical access to the HD-DVD.

To perform the foregoing recording/reproduction with respect to the optical disc, the object optical disc has to be distinguished whether being the Blu-ray Disc or the HD-DVD. This process is known in the art. A predetermined process may be performed according to the following procedure. For example, the object optical disc is irradiated with the laser beam through either objective lens (for instance, the first objective lens 18) through the same steps as the foregoing recording/reproduction operation. At the same time, the movable member 30 of the actuator unit 3 is moved to come closer to the optical disc at a constant speed. When a time necessary for the light reflected by the optical disc surface to reach the first photodetector 15 during such process is represented by t1, and a time necessary for the light reflected by the recording layer of the optical disc to reach the first photodetector 15 by t2, the time difference Δt (=t1−t2) can be obtained as different values according to the cover layer thickness of the optical disc. The type of the object optical disc can thus be identified, before performing the recording/reproduction.

Accordingly, with the optical pickup A1 according to this embodiment, the first light source 10 and the first photodetector 15 can be used for both of the Blu-ray Disc and the HD-DVD, which leads to increased commonality of the optical components, and to relatively simplified structure.

To be more detailed, it suffices providing just a single first light source 10 constituted of a blue laser diode, which is relatively expensive, and therefore the cost of the device as a whole can be reduced, while upgrading the performance. In other words, the number of optical components mounted on each optical pickup A1 can be minimized and the optical pickup A1 can be made smaller in dimensions and lighter in weight, which leads to reduced power consumption by reciprocating the optical pickup A1.

Regarding other embodiments to be described below, constituents that are the same as or similar to those of the foregoing embodiment are given identical or similar numerals, and the description thereof will not be repeated.

### Second Embodiment

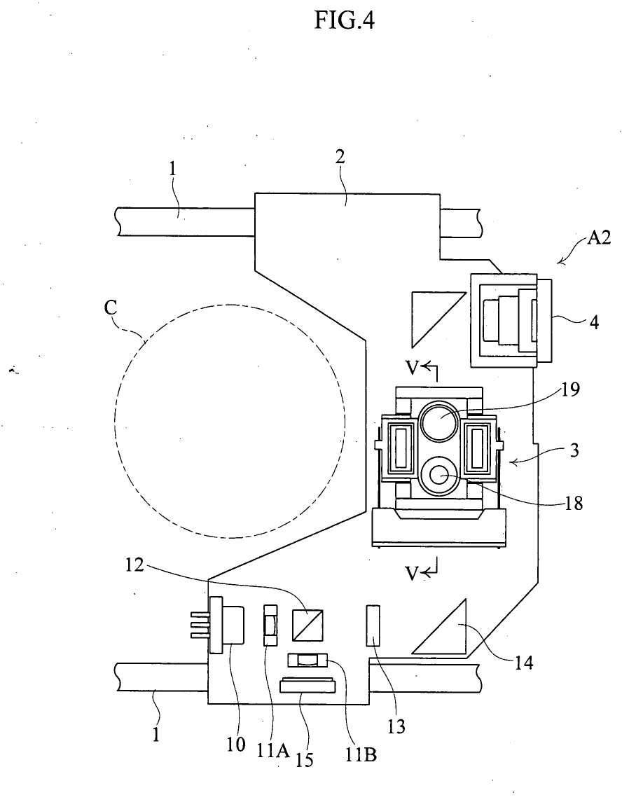

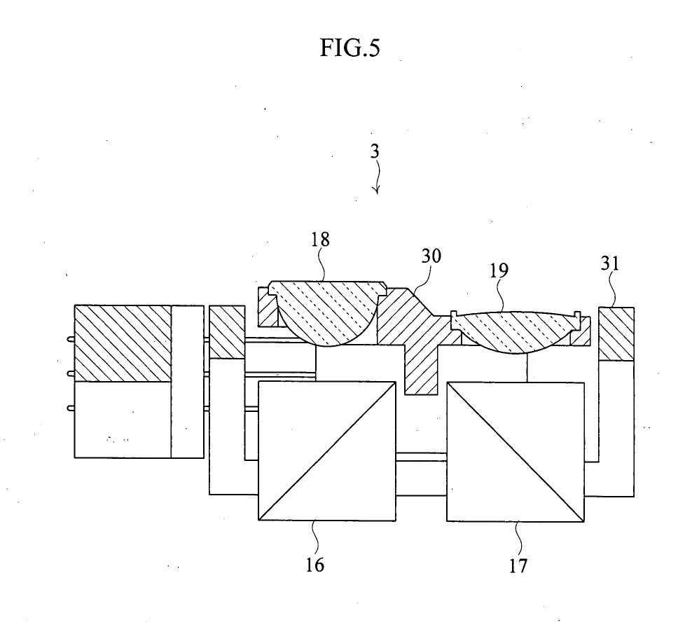

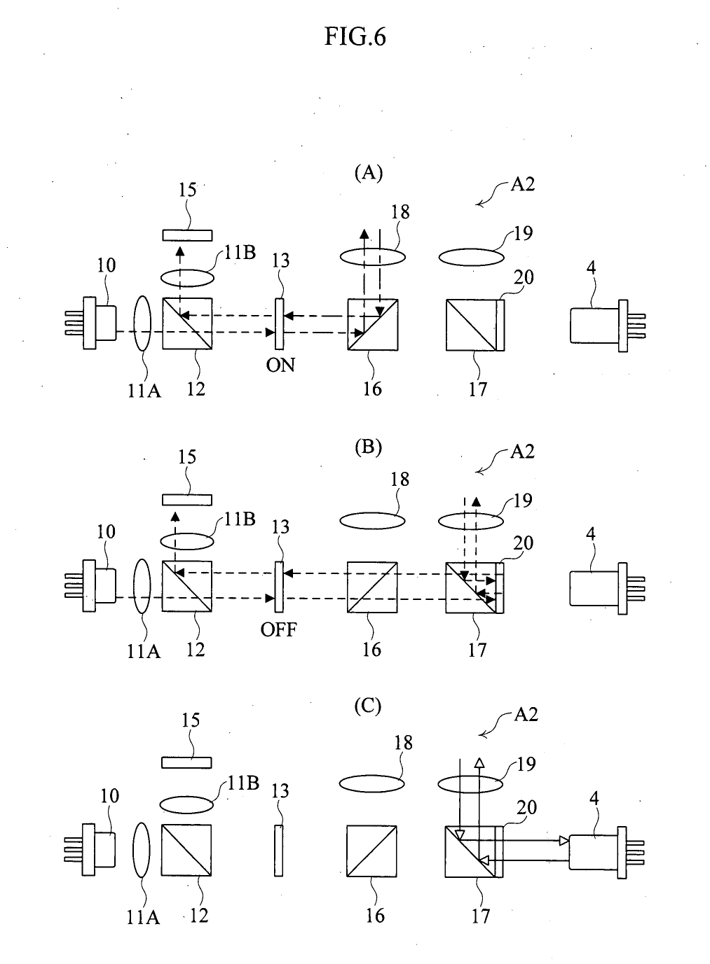

As shown in FIGS. 4 to 6(C), an optical pickup A2 is also compatible with a CD and a DVD, in addition to the Blu-ray Disc and the HD-DVD, which are examples of the optical disc. The optical pickup A2 includes, as shown in FIG. 4, a laser unit 4 including therein a second light source (not shown) and so on, and a fixed mirror 5 serving as an optical component for the CD/DVD mounted on the carriage plate 2, in addition to the components referred to in the first embodiment. The first objective lens 18 mounted on the movable member 30 of the actuator unit 3 is exclusively for the Blu-ray Disc, but the second objective lens 19 includes a compatible lens applicable to the CD/DVD, not only to the HD-DVD. Further, between the upward reflection mirror 17 and the laser unit 4 (second light source), a dichroic mirror 20 is provided (Ref. FIGS. 6(A) to 6(C)). The dichroic mirror 20 has a characteristic of reflecting the blue laser beam and transmitting the red laser beam.

Referring to FIGS. 6(A) to 6(C), the laser unit 4 includes one each of the second light sources (not shown) for the CD and the DVD. The laser unit 4 also includes optical components such as a photodetector (not shown) for the CD/DVD, incorporated therein. The second light sources for the CD/DVD are generally constituted of the red laser diode, and the second light source for the CD emits the laser beam of the wavelength band of generally 780 nm, suitable for the CD. The second light source for the DVD emits the laser beam of the wavelength band of generally 660 nm, suitable for the DVD. The laser beam emitted by the first light source 10 to be incident upon the polarizing beam splitter 16 and the laser beam emitted by the second light source to be incident upon the upward reflection mirror 17 are on a same optical axis, but incident from opposite directions. For the sake of explicitness, the second light sources will hereinafter be referred to collectively as the light source for CD/DVD, without distinction between that for the CD and that for the DVD. The laser beam emitted by the first light source 10 is indicated by solid arrow heads, and the laser beam emitted by the second light source by open arrow heads, in FIGS. 6(A) to 6(C).

The upward reflection mirror 17 according to this embodiment is constituted of a half mirror, and located immediately under the second objective lens 19. The laser beam incident upon the upward reflection mirror 17 from the polarizing beam splitter 16 is once transmitted through the mirror surface and reflected by the dichroic mirror 20, and then reflected again by the mirror surface so as to proceed to the second objective lens 19, and the laser beam returning from the second objective lens 19 is again reflected by the upward reflection mirror 17, thus to travel toward the polarizing beam splitter 16. The laser beam returning from the second objective lens 19 is reflected by the mirror surface so as to proceed toward the dichroic mirror 20, and is thereby reflected so as to pass through the mirror surface again and return to the polarizing beam splitter 16.

Optical effects that take place when the recording/reproduction is performed with respect to the Blu-ray Disc, to the HD-DVD, and to the DVD/CD will be described below, referring to FIGS. 6(A) to 6(C).

Firstly as shown in FIG. 6(A), the recording/reproduction with respect to the Blu-ray Disc may be performed as described referring to FIG. 3(A). Accordingly, optical access to the Blu-ray Disc can be performed with high precision.

As shown in FIG. 6(B), for the recording/reproduction with respect to the HD-DVD, the same process as those described referring to FIG. 3(B) may be performed, up to the step where the P-polarized laser beam is incident upon the upward reflection mirror 17.

The laser beam incident upon the upward reflection mirror 17 is the blue laser beam, and hence the laser beam is transmitted through the surface of the upward reflection mirror 17 and reflected by the dichroic mirror 20, and then again reflected by the mirror surface thus to proceed toward the second objective lens 19. Thus, the blue laser beam illuminates the HD-DVD via the second objective lens 19.

The blue laser beam illuminating the HD-DVD is reflected by the recording layer of the HD-DVD, and returns to the surface of the upward reflection mirror 17. The blue laser beam reflected by the mirror surface is again reflected by the dichroic mirror 20, and then transmitted through the mirror surface thus returning to the polarizing beam splitter 16. Since the blue laser beam which has returned to the polarizing beam splitter 16 is the P-polarized laser beam, the blue laser beam is transmitted through the polarizing beam splitter 16, thus returning to the polarization control element 13.

The P-polarized laser beam which has returned to the polarization control element 13 travels as described referring to FIG. 3(B), to be detected by the first photodetector 15. Such arrangement enables precisely making optical access to the HD-DVD.

Referring to FIG. 6(C), when the recording/reproduction is performed with respect to the CD/DVD, the second light source of the laser unit 4 emits the red laser beam. The red laser beam is incident upon the dichroic mirror 20 in an opposite direction to the blue laser beam.

The red laser beam is reflected, upon passing through the dichroic mirror 20, by the surface of the upward reflection mirror 17, and proceeds toward the second objective lens 19. Thus, the red laser beam illuminates the CD/DVD via the second objective lens 19.

The red laser beam illuminating the CD/DVD is reflected by the recording layer of the CD/DVD, thereby returning to the surface of the upward reflection mirror 17. The red laser beam reflected by the mirror surface is again transmitted through the dichroic mirror 20, and returns to the laser unit 4. In the laser unit 4, the photodetector for the CD/DVD detects the red laser beam which has returned from the CD/DVD. Such arrangement enables precisely making optical access to the CD/DVD.

Accordingly, with the optical pickup A2 according to this embodiment, the upward reflection mirror 17 and the second objective lens 19 can be used for both of the HD-DVD and the CD/DVD, which permits applying the optical pickup A2 for the four types of optical discs, with a slight increase in number of optical components.

Also, the blue laser beam and the red laser beam enter and go out of the actuator unit 3 from and to the opposite directions, which allows reducing the size of the optical pickup A2 as much as possible, and thus efficiently reducing the dimensions and weight of the optical pickup A2.

### Third Embodiment

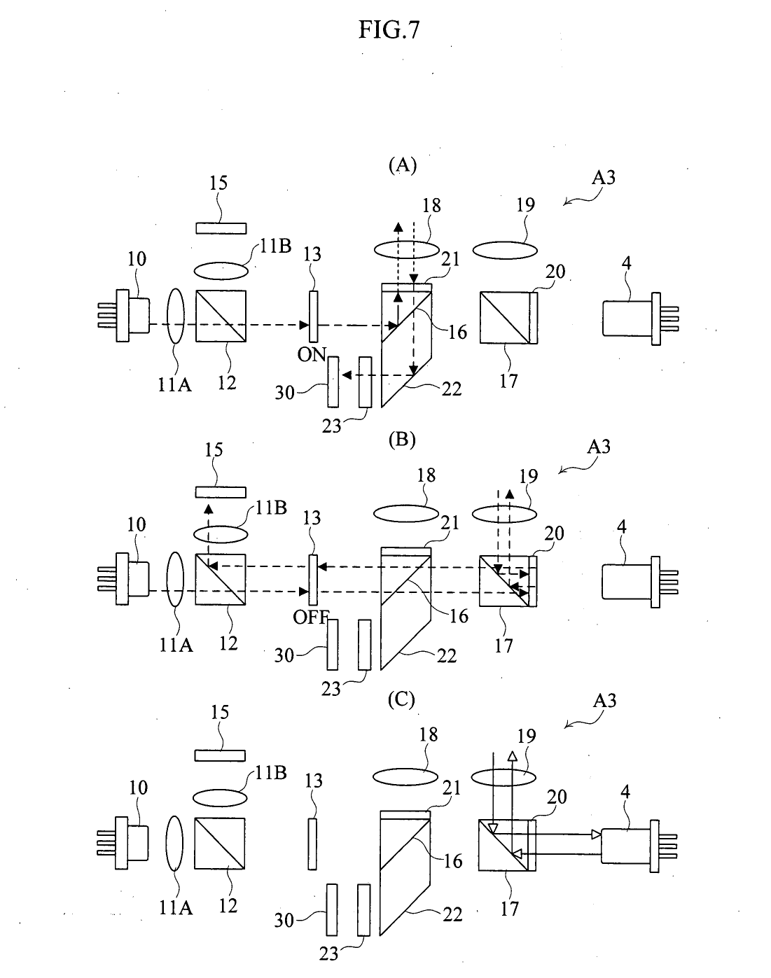

As shown in FIGS. 7(A) to 7(C), an optical pickup A3 according to this embodiment is also compatible with the CD and the DVD, in addition to the Blu-ray Disc and the HD-DVD. The optical pickup A3 includes a λ/4 plate 21, a fixed mirror 22, an optical lens 23, and a second photodetector 30, in addition to the components included in the second embodiment.

The λ/4 plate 21 is a refracting plate made of an optical material having birefringent nature such as crystal, and serves to grant a phase difference of 90 degrees to a linearly polarized laser beam incident thereon, and to emit such laser beam. In other words, the λ/4 plate 21 converts the linearly polarized laser beam incident thereon into a circularly polarized laser beam, and the circularly polarized laser beam incident thereon into the linearly polarized laser beam. The λ/4 plate 21 is located between the polarizing beam splitter 16 and the first objective lens 18. In FIGS. 7(A) to 7(C), the circularly polarized laser beam with the phase difference of 90 degrees is indicated by dot lines.

The fixed mirror 22 is of a total reflection type, and located immediately under the polarizing beam splitter 16. The second photodetector 30 is disposed so as to detect the laser beam reflected by the fixed mirror 22, via the optical lens 23. In other words, the second photodetector 30 is provided for the Blu-ray Disc. Accordingly, the first photodetector 15 is used for the HD-DVD.

In this embodiment, as shown in FIGS. 7(B) and 7(C), the recording/reproduction with respect to the HD-DVD and the CD/DVD may be performed as described referring to FIGS. 6(B) and 6(C). Such arrangement enables precisely making optical access to the HD-DVD and the CD/DVD.

As shown in FIG. 7(A), in the case of performing the recording/reproduction with respect to the Blu-ray Disc, the process is the same as that described referring to FIG. 3(A) up to the step where the S-polarized laser beam is incident upon the polarizing beam splitter 16.

The S-polarized laser beam reflected by the polarizing beam splitter 16 is directed to the first objective lens 18 through the λ/4 plate 21. At this stage, the S-polarized laser beam is converted from the linearly polarized light to the circularly polarized light by the λ/4 plate 21. Thus, the Blu-ray Disc is irradiated with the circularly polarized laser beam through the first objective lens 18.

The circularly polarized laser beam illuminating the Blu-ray Disc is reflected by the recording layer of the Blu-ray Disc, thereby returning to the polarizing beam splitter 16 through the first objective lens 18 and the λ/4 plate 21. Here, the circularly polarized laser beam is converted by the λ/4 plate 21 from the circularly polarized light to the linearly polarized light. Thus, the S-polarized laser beam emitted to the Blu-ray Disc is transmitted through the λ/4 plate 21 twice, to be thereby subjected to the phase shift of 180 degrees, and thus to return to the polarizing beam splitter 16, in the form of the P-polarized laser beam.

Accordingly, the P-polarized laser beam which has returned to the polarizing beam splitter 16 is transmitted therethrough and reflected by the fixed mirror 22, to be detected by the second photodetector 30 via the optical lens 23.

Under such configuration, the second photodetector 30 and the first photodetector 15 are individually provided for the Blu-ray Disc and the HD-DVD respectively, which allows utilizing the appropriate photodetector for each optical disc, and enables precisely making optical access to the HD-DVD.

### Fourth Embodiment

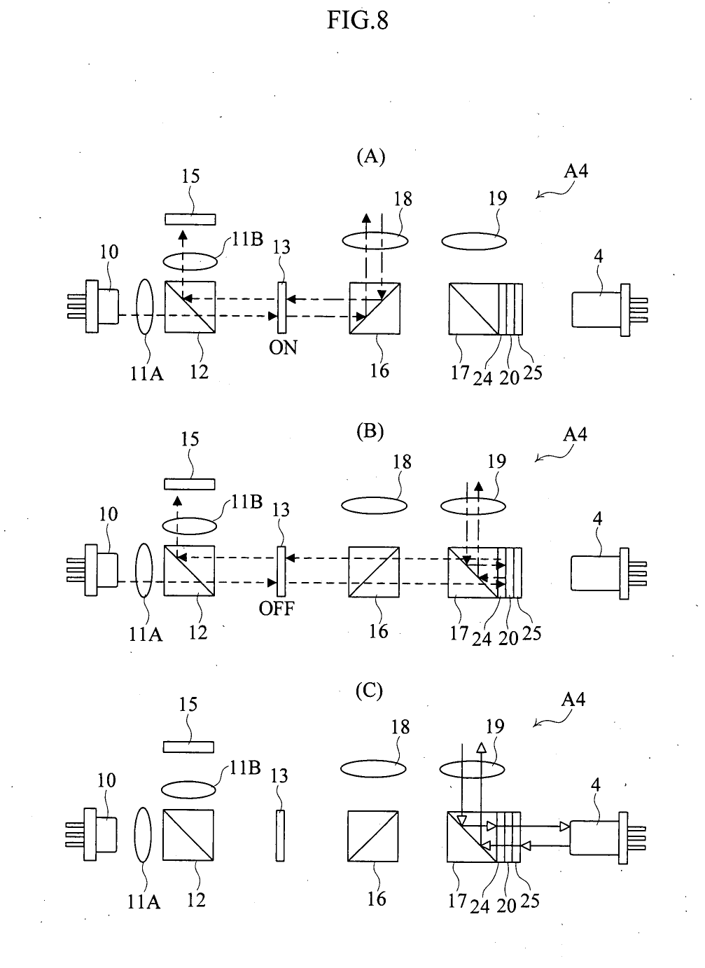

As shown in FIGS. 8(A) to 8(C), an optical pickup A4 according to this embodiment is of a structure similar to that of the second embodiment (Ref. FIGS. 6(A) to 6(C)). The optical pickup A4 includes a λ/4 plate 24 for the blue wavelength band of generally 405 nm, and a phase correction plate 25 that corrects the phase of the red laser beam, in addition to those components included in the second embodiment. In this embodiment, the upward reflection mirror 17 is constituted of a half mirror having a similar polarization characteristic to that of the polarizing beam splitter 16.

The λ/4 plate 24 for the blue wavelength band has a similar optical characteristic to that of the λ/4 plate 21 described referring to the third embodiment, and grants the phase difference of accurately 90 degrees, exclusively to the linearly polarized laser beam of the blue wavelength band of generally 405 nm. The λ/4 plate 24 for the blue wavelength band is located between the dichroic mirror 20 and the upward reflection mirror 17.

The phase correction plate 25 serves to correct the phase difference created when the red laser beam passes through the λ/4 plate 24 for the blue wavelength band, and is located between the λ/4 plate 24 for the blue wavelength band and the second light source (laser unit 4) that emits the red laser beam.

As shown in FIG. 8(A), in this embodiment the recording/reproduction with respect to the Blu-ray Disc may be performed through similar steps to those described referring to FIG. 6(A). Accordingly, precise optical access can be achieved to the Blu-ray Disc.

As shown in FIG. 8(B), for the recording/reproduction with respect to the HD-DVD, the same process as that described referring to FIG. 6(B) may be performed, up to the step where the P-polarized laser beam is transmitted through the upward reflection mirror 17.

Since the upward reflection mirror 17 is constituted of the polarizing half mirror, substantially 100% of the P-polarized laser beam is transmitted through the upward reflection mirror 17, to be incident upon the λ/4 plate 24 for the blue wavelength band.

The P-polarized laser beam incident upon the λ/4 plate 24 for the blue wavelength band is thereby converted from the linearly polarized light into the circularly polarized light, and then reflected by the dichroic mirror 20 so as to be again transmitted through the λ/4 plate 24 for the blue wavelength band, thus reaching the surface of the upward reflection mirror 17. In other words, the blue P-polarized laser beam passes through the λ/4 plate 24 for the blue wavelength band twice in both directions, to be thereby subjected to the phase shift of 180 degrees, and resultantly turns into the S-polarized laser beam and substantially 100% thereof is reflected by the upward reflection mirror 17 toward the second objective lens 19. Accordingly, the HD-DVD is irradiated with the blue S-polarized laser beam of a sufficient light quantity.

The blue S-polarized laser beam illuminating HD-DVD is reflected by the recording layer of the HD-DVD, thereby returning to the surface of the upward reflection mirror 17. Substantially 100% of the S-polarized laser beam is reflected by the mirror surface, and again passes through the λ/4 plate 24 for the blue wavelength band twice so as to be reflected by the dichroic mirror 20 and to thus return to the surface of the upward reflection mirror 17. In other words, the blue S-polarized laser beam which has returned from the HD-DVD passes through the λ/4 plate 24 for the blue wavelength band twice in both directions, to be thereby subjected to the phase shift of 180 degrees, and resultantly turns into the P-polarized laser beam and substantially 100% thereof is transmitted through the upward reflection mirror 17.

Here, since the blue laser beam which has returned to the polarizing beam splitter 16 through the upward reflection mirror 17 is the P-polarized laser beam, the blue laser beam is transmitted through the polarizing beam splitter 16, thus returning to the polarization control element 13.

Thereafter, the P-polarized laser beam which has returned to the polarization control element 13 is detected by the first photodetector 15, through the process as described referring to FIG. 3(B). Thus, the optical access to the HD-DVD can be achieved with precision.

As shown in FIG. 8(C), in the case of performing the recording/reproduction with respect to the CD/DVD, the second light source of the laser unit 4 emits the red laser beam. The red laser beam is transmitted through the phase correction plate 25, to be thereby subjected to a predetermined phase shift, and transmitted through the dichroic mirror 20.

The red laser beam transmitted through the dichroic mirror 20 is incident upon the surface of the upward reflection mirror 17, through the λ/4 plate 24 for the blue wavelength band. The red laser beam is further reflected by the surface of the upward reflection mirror 17 so as to proceed toward the second objective lens 19, and to illuminate the CD/DVD through the second objective lens 19.

The red laser beam illuminating the CD/DVD is reflected by the recording layer of the CD/DVD, to thereby return to the surface of the upward reflection mirror 17. The red laser beam reflected by the mirror surface is sequentially transmitted through the λ/4 plate 24 for the blue wavelength band, the dichroic mirror 20, and the phase correction plate 25, thus returning to the laser unit 4. In the laser unit 4, the photodetector for the CD/DVD detects the red laser beam which has returned from the CD/DVD. In other words, the red laser beam illuminating the CD/DVD is subjected to the phase shift because of passing through the λ/4 plate 24 for the blue wavelength band twice, however the red laser beam returns to the laser unit 4 with the phase shift properly corrected by the phase correction plate 25, which allows making the optical access to the CD/DVD with precision.

In the optical pickup A4 according to this embodiment, therefore, since the upward reflection mirror 17 is constituted of the polarizing half mirror, the HD-DVD can be irradiated with the blue laser beam of a sufficient light quantity. The laser beam reflected by the HD-DVD also has a sufficient light quantity for the first photodetector 15 to detect the laser beam. Consequently, utilizing the first photodetector 15 for the Blu-ray Disc and the HD-DVD in common allows making the optical access to the optical disc with higher precision.

### Fifth Embodiment

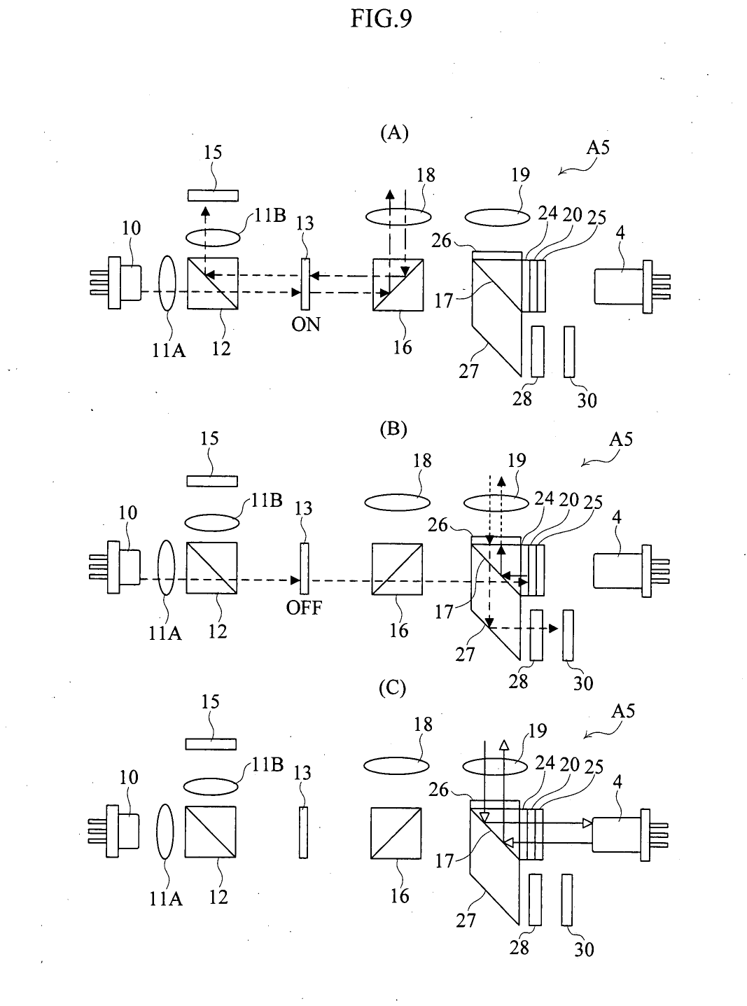

As shown in FIGS. 9(A) to 9(C), an optical pickup A5 according to this embodiment is of a structure similar to that of the fourth embodiment (Ref. FIGS. 8(A) to 8(C)). The optical pickup A5 includes a λ/4 plate 26, a fixed mirror 27, an optical lens 28, and the second photodetector 30, in addition to those components included in the fourth embodiment.

The λ/4 plate 26 is, as the one described referring to the third embodiment, a refracting plate made of an optical material having birefringent nature such as crystal, and serves to grant a phase difference of 90 degrees to a linearly polarized laser beam incident thereon, and to emit such laser beam. The λ/4 plate 26 is located between the upward reflection mirror 17 and the second objective lens 19. The upward reflection mirror 17 is, as the one according to the fourth embodiment, constituted of the polarizing half mirror.

The fixed mirror 27 is of a total reflection type, and located immediately under the upward reflection mirror 17. The second photodetector 30 is disposed so as to detect the laser beam reflected by the fixed mirror 27, via the optical lens 28. In other words, the second photodetector 30 is provided for the HD-DVD. Accordingly, the first photodetector 15 is used for the Blu-ray Disc.

As shown in FIG. 9(A), in this embodiment the recording/reproduction with respect to the Blu-ray Disc may be performed through similar steps to those described referring to FIG. 6(A). Accordingly, precise optical access can be achieved to the Blu-ray Disc.

As shown in FIG. 9(B), for the recording/reproduction with respect to the HD-DVD, the same process as that described referring to FIG. 8(B) may be performed, up to the step where the S-polarized laser beam is emitted from the upward reflection mirror 17 toward the second objective lens 19.

The S-polarized laser beam emitted from the upward reflection mirror 17 proceeds toward the second objective lens 19 through the λ/4 plate 26. In this process, the S-polarized laser beam is converted by the λ/4 plate 26 from the linearly polarized light to the circularly polarized light. Thus, the HD-DVD is irradiated with the circularly polarized laser beam, through the second objective lens 19.

The circularly polarized laser beam illuminating the HD-DVD is reflected by the recording layer of the HD-DVD, thereby returning to the upward reflection mirror 17 through the second objective lens and the λ/4 plate 26. Here, the circularly polarized laser beam is converted by the λ/4 plate 26 from the circularly polarized light into the linearly polarized light. Thus, the laser beam emitted to the HD-DVD is transmitted through the λ/4 plate 26 twice, to be thereby subjected to the phase shift of 180 degrees, and thus to return to the upward reflection mirror 17, in the form of the P-polarized laser beam.

Accordingly, the P-polarized laser beam which has returned to the upward reflection mirror 17 is transmitted through the upward reflection mirror 17 and reflected by the fixed mirror 27, after which the second photodetector 30 detects the P-polarized laser beam via the optical lens 28.

Under such configuration also, the second photodetector 30 and the first photodetector 15 are individually provided for the HD-DVD and the Blu-ray Disc respectively, which allows utilizing the appropriate photodetector for each optical disc, and enables precisely making optical access to the HD-DVD.

As shown in FIG. 9(C), in the case of performing the recording/reproduction with respect to the CD/DVD, the red laser beam emitted by the second light source of the laser unit 4 is sequentially transmitted through the phase correction plate 25, the dichroic mirror 20, the λ/4 plate 24 for the blue wavelength band, the upward reflection mirror 17, the λ/4 plate 26, and the second objective lens 19, to thereby illuminate the CD/DVD.

The red laser beam illuminating the CD/DVD is reflected by the recording layer of the CD/DVD, so as to return to the laser unit 4 along the foregoing path in the opposite direction. Such arrangement allows making the optical access with precision, also to the CD/DVD.

The optical pickup A5 according to this embodiment enables, therefore, making the optical access to the Blu-ray Disc and the HD-DVD, with higher precision.

### Sixth Embodiment

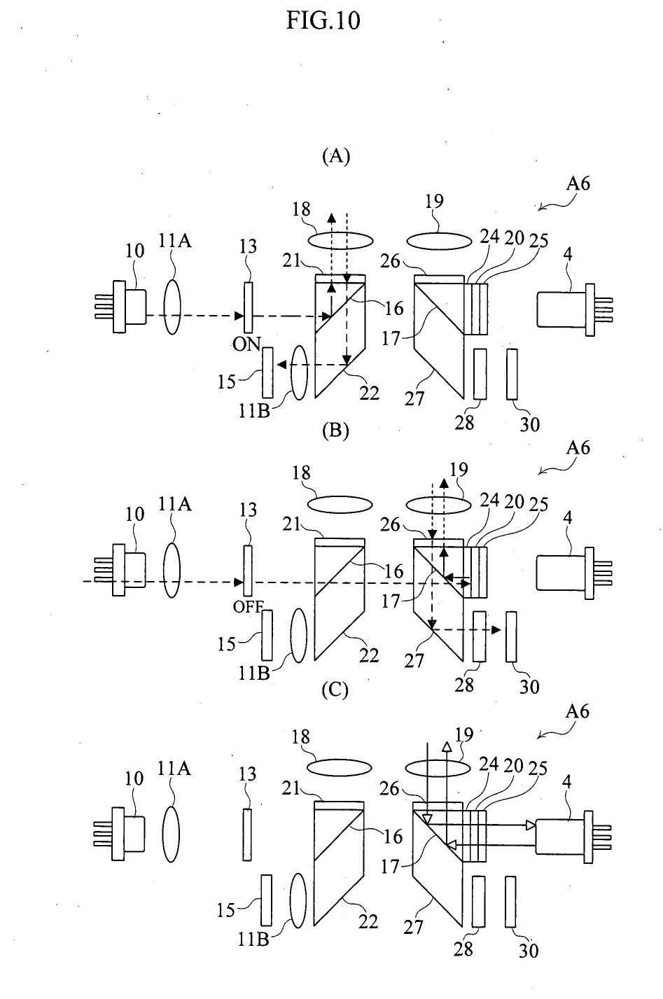

As shown in FIGS. 10(A) to 10(C), an optical pickup A6 according to this embodiment has a configuration in which the structure of the third embodiment and that of the fifth embodiment are combined (Ref. FIGS. 7(A) to 7(C) and 9(A) to 9(C)). From the optical pickup A6 the intermediate half mirror is excluded. The first photodetector 15 is disposed so as to detect the laser beam returning sequentially through the first objective lens 18, the λ/4 plate 21, the polarizing beam splitter 16, the fixed mirror 22, and the collimator lens 11B. The second photodetector 30 is disposed so as to detect the laser beam returning sequentially through the second objective lens 19, the λ/4 plate 26, the upward reflection mirror 17, the fixed mirror 27, and the optical lens 28. Accordingly, the first photodetector 15 is provided for the Blu-ray Disc, and the second photodetector 30 is provided for the HD-DVD. The routing of the laser beam to the Blu-ray Disc and the HD-DVD is generally the same as that adopted in the third and the fifth embodiment.

The above configuration allows substantially minimizing attenuation of the laser beam that takes place because of passing through the intermediate half mirror, thereby efficiently emitting the laser beam to both of the Blu-ray Disc and the HD-DVD.

### Seventh Embodiment

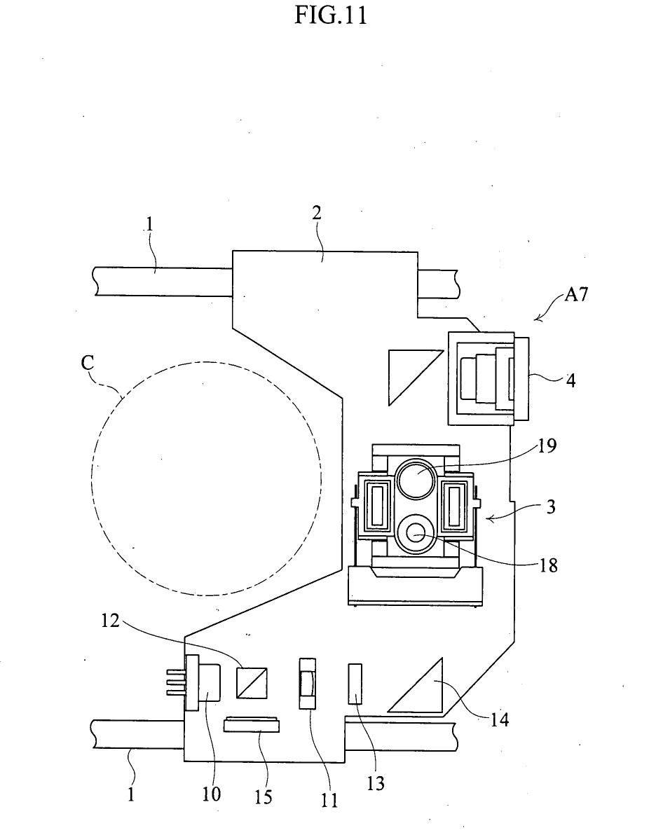

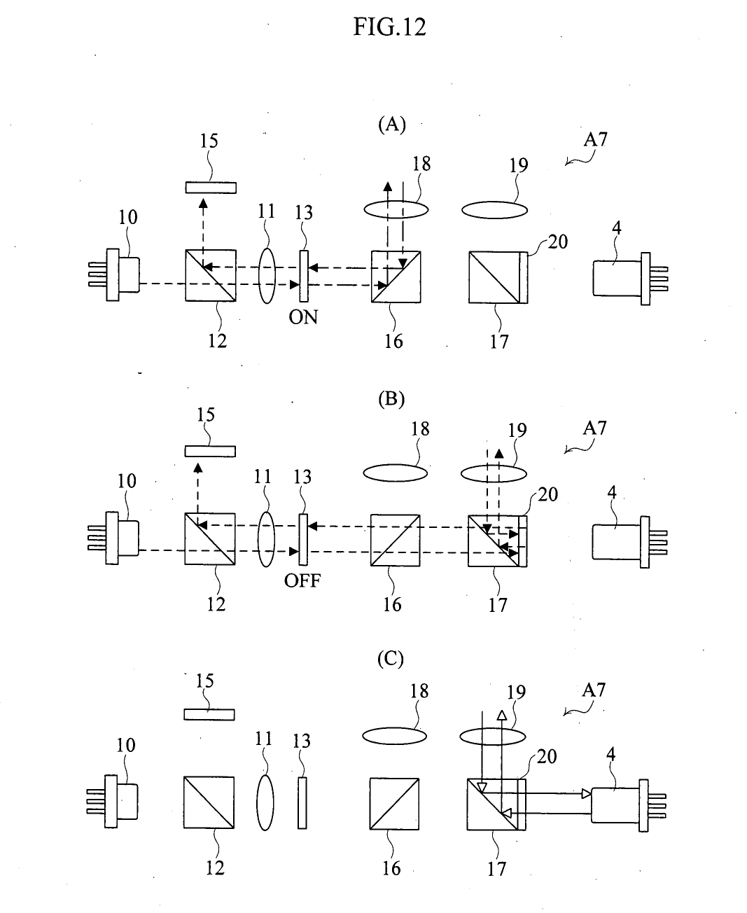

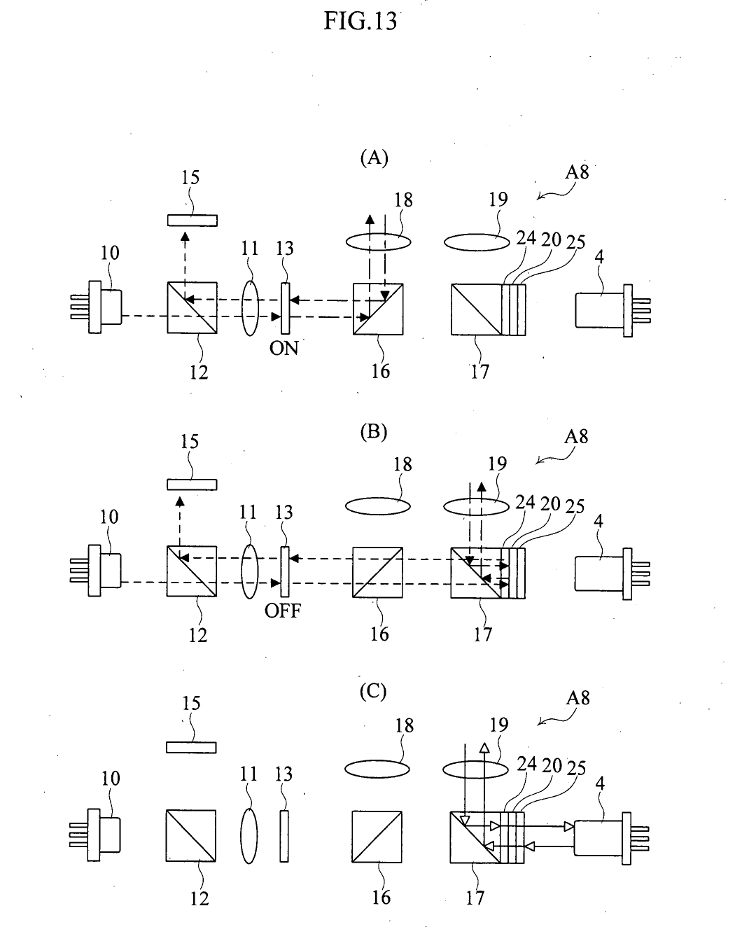

As shown in FIGS. 11 and 12(A) to 12(C), an optical pickup A7 according to this embodiment is of a structure similar to that of the second embodiment (Ref. FIGS. 6(A) to 6(C)). The optical pickup A7 includes the collimator lens 11 located between the intermediate half mirror 12 and the polarization control element 13, which constitute the optical path for the blue beam. Regarding the routing of the blue laser beam, as shown in FIGS. 13(A) and 13(B), the laser beam transmitted through the intermediate half mirror 12 is incident upon the polarization control element 13 through the collimator lens 11. On the other hand, the laser beam returning from the polarization control element 13 is again transmitted through the collimator lens 11 thus to return to the intermediate half mirror 12, so as to be directly led to the first photodetector 15 from the intermediate half mirror 12.

Such configuration allows reducing the number of lenses serving as the optical components, thus contributing to reducing the dimensions and weight of the optical pickup A7.

### Eighth Embodiment

As shown in FIGS. 13(A) to 13(C), an optical pickup A8 according to this embodiment is of a structure similar to that of the fourth embodiment (Ref. FIGS. 8(A) to 8(C)). Specifically, the optical pickup A8 also includes the collimator lens 11 located between the intermediate half mirror 12 and the polarization control element 13, which constitute the optical path for the blue beam. The routing of the blue laser beam is similar to that according to the seventh embodiment. Such configuration also allows reducing the number of lenses serving as the optical components, thus contributing to reducing the dimensions and weight of the optical pickup A8.

### Ninth Embodiment

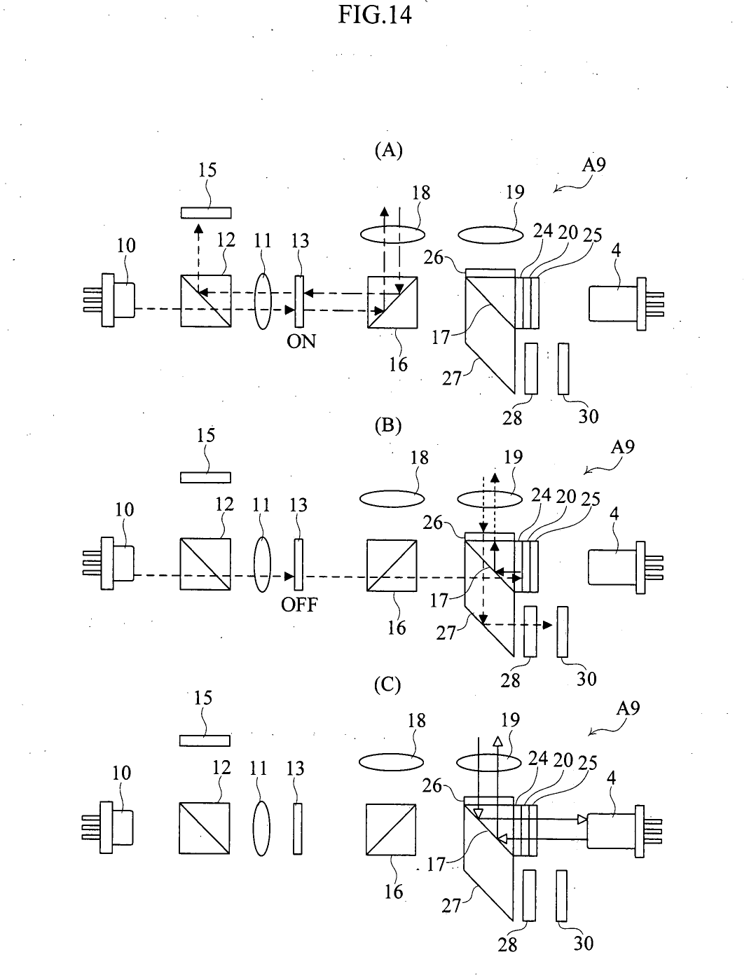

As shown in FIG. 14(A) to 14(C), an optical pickup A9 according to this embodiment is of a structure similar to that of the fifth embodiment (Ref. FIGS. 9(A) to 9(C)). Specifically, the optical pickup A9 also includes the collimator lens 1 located between the intermediate half mirror 12 and the polarization control element 13, which constitute the optical path for the blue beam. Such configuration also allows reducing the number of lenses serving as the optical components, thus contributing to reducing the dimensions and weight of the optical pickup A9.

### Tenth Embodiment

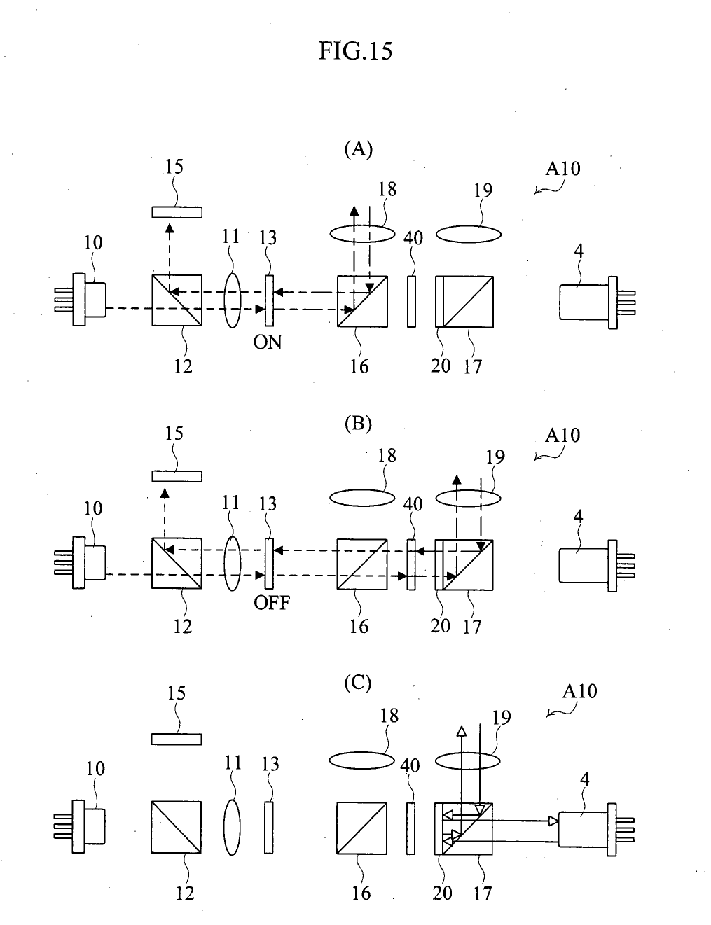

As shown in FIG. 15(A) to 15(C), an optical pickup A10 according to this embodiment is of a structure similar to that of the second and the seventh embodiment (Ref. FIGS. 6(A) to 6(C) and 11). Specifically, the optical pickup A10 also includes the collimator lens 11 located between the intermediate half mirror 12 and the polarization control element 13, which constitute the optical path for the blue beam. The dichroic mirror 20 is located between the polarizing beam splitter 16 and the upward reflection mirror 17, and further a λ/2 plate 40 is provided between the dichroic mirror 20 and the polarizing beam splitter 16.

The dichroic mirror 20 according to this embodiment has a characteristic of transmitting the blue laser beam and reflecting the red laser beam. The λ/2 plate 40 is a refracting plate made of an optical material having birefringent nature such as crystal, and serves to grant a phase difference of 180 degrees to a linearly polarized laser beam incident thereon, and to emit such laser beam. In other words, the λ/2 plate 40 converts the P-polarized laser beam into the S-polarized laser beam thus emitting the converted beam, and converts the S-polarized laser beam into the P-polarized laser beam thus emitting the converted beam.

In this embodiment, as shown in FIG. 15(A), for the recording/reproduction with respect to the Blu-ray Disc, generally the same process as that described referring to FIG. 3(A) or the like may be performed.

As shown in FIG. 15(B), for the recording/reproduction with respect to the HD-DVD, the same process as that described referring to FIG. 3(B) or the like may be performed, up to the step where the blue P-polarized laser beam is transmitted through the polarizing beam splitter 16.

The blue P-polarized laser beam transmitted through the polarizing beam splitter 16 proceeds to the dichroic mirror 20 through the λ/2 plate 40. In this process, the P-polarized laser beam is converted by the λ/2 plate 40 into the S-polarized laser beam. Since this is the blue laser beam, the laser beam is reflected by the surface of the upward reflection mirror 17 after passing through the dichroic mirror 20, so as to proceed to the second objective lens 19. Accordingly, the HD-DVD is irradiated with the blue S-polarized laser beam through the second objective lens 19.

The blue S-polarized laser beam illuminating the HD-DVD is reflected by the recording layer of the HD-DVD, to thereby return to the surface of the upward reflection mirror 17. The laser beam reflected by the mirror surface is again transmitted through the dichroic mirror 20 and incident upon the λ/2 plate 40. At this stage, since the laser beam incident upon the λ/2 plate 40 is S-polarized, the λ/2 plate 40 emits the P-polarized laser beam toward the polarizing beam splitter 16.

The subsequent routing of the laser beam is similar to that described referring to FIG. 3(B) or the like. Specifically, the P-polarized laser beam which has returned to the polarizing beam splitter 16 is transmitted sequentially through the polarizing beam splitter 16, the polarization control element 13, the collimator lens 11, and the intermediate half mirror 12, thus to be detected by the first photodetector 15.

As shown in FIG. 15(C), in the case of performing the recording/reproduction with respect to the CD/DVD, the second light source of the laser unit 4 emits the red laser beam. The red laser beam is transmitted through the surface of the upward reflection mirror 17, and then incident upon the dichroic mirror 20.

The red laser beam incident upon the dichroic mirror 20 is thereby reflected, thus to return to the surface of the upward reflection mirror 17. The red laser beam is reflected by the surface of the upward reflection mirror 17 so as to proceed to the second objective lens 19, and then illuminates the CD/DVD through the second objective lens 19.

The red laser beam illuminating the CD/DVD is reflected by the recording layer of the CD/DVD, to thereby return to the surface of the upward reflection mirror 17. The red laser beam reflected by the mirror surface is again reflected by the dichroic mirror 20, thus returning to the laser unit 4. In the laser unit 4, the photodetector for the CD/DVD detects the red laser beam which has returned from the CD/DVD.

Therefore, the optical pickup A10 according to this embodiment also provides the similar advantageous effects to those offered by, for example, the second embodiment.

### Eleventh Embodiment

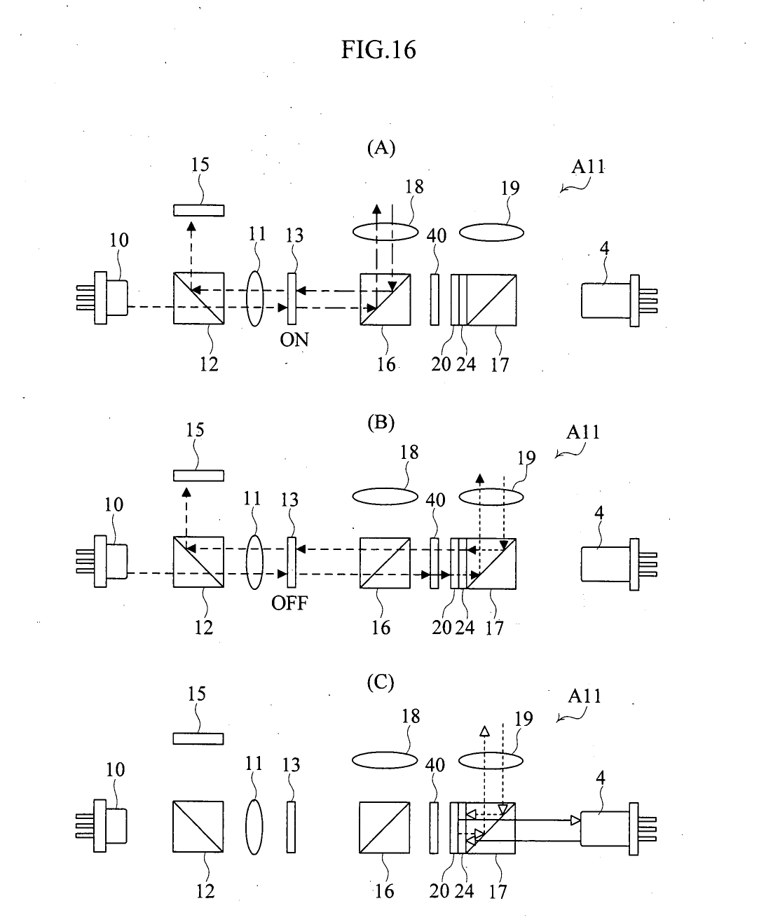

As shown in FIGS. 16(A) to 16(C), an optical pickup A11 according to this embodiment has a structure similar to that of the fourth, the eighth, and also the tenth embodiment (Ref. FIGS. 8(A) to 8(C), 13(A) to 13(C) and 15(A) to 15(C)). Specifically, the optical pickup A11 includes the λ/4 plate 24 for the blue wavelength band located between the dichroic mirror 20 and the upward reflection mirror 17. The upward reflection mirror 17 is constituted of the polarizing half mirror. The dichroic mirror 20 has the characteristic of transmitting the blue laser beam and reflecting the red laser beam.

In this embodiment also, as shown in FIG. 16(A), the recording/reproduction process with respect to the Blu-ray Disc is generally the same as that described referring to FIG. 15(A) or the like.

As shown in FIG. 16(B), for the recording/reproduction with respect to the HD-DVD, the same process as that described referring to FIG. 15(B) or the like may be performed, up to the step where the blue P-polarized laser beam is transmitted through the λ/2 plate 40.

The blue laser beam converted into the S-polarized beam upon passing through the λ/2 plate 40 is transmitted through the dichroic mirror 20 and incident upon the λ/4 plate 24 for the blue wavelength band.

The S-polarized laser beam incident upon the λ/4 plate 24 for the blue wavelength band is converted by the λ/4 plate 24 from the linearly polarized light into the circularly polarized light, after which substantially 100% of such light is reflected by the upward reflection mirror 17 so as to proceed to the second objective lens 19. Accordingly, the HD-DVD is irradiated with the blue circularly polarized laser beam of a sufficient light quantity.

The blue circularly polarized laser beam illuminating the HD-DVD is reflected by the recording layer of the HD-DVD, to thereby return to the surface of the upward reflection mirror 17. The circularly polarized laser beam, substantially 100% of which is reflected by the mirror surface, is again transmitted sequentially through the λ/4 plate 24 for the blue wavelength band, the dichroic mirror 20 and the λ/2 plate 40, thus returning to the polarizing beam splitter 16. Accordingly, such configuration also provides the laser beam returning from the HD-DVD with a sufficient light quantity for the detection by the first photodetector 15.

As shown in FIG. 16(C), in the case of performing the recording/reproduction with respect to the CD/DVD, the second light source of the laser unit 4 emits the red laser beam. The red laser beam is transmitted through the surface of the upward reflection mirror 17 and the λ/4 plate 24 for the blue wavelength band, and then incident upon the dichroic mirror 20.

The red laser beam incident upon the dichroic mirror 20 is thereby reflected, thus to return to the surface of the upward reflection mirror 17 through the λ/4 plate 24 for the blue wavelength band. The red laser beam is reflected by the surface of the upward reflection mirror 17 so as to proceed to the second objective lens 19, and to illuminate the CD/DVD through the second objective lens 19.

The red laser beam illuminating the CD/DVD is reflected by the recording layer of the CD/DVD, to thereby return to the surface of the upward reflection mirror 17. The red laser beam reflected by the mirror surface is again transmitted through the λ/4 plate 24 for the blue wavelength band and reflected by the dichroic mirror 20, and further transmitted through the surface of the upward reflection mirror 17 thus returning to the laser unit 4. In the laser unit 4, the photodetector for the CD/DVD detects the red laser beam which has returned from the CD/DVD.

Therefore, the optical pickup A11 according to this embodiment also provides the similar advantageous effects to those offered by, for example, the fourth embodiment.

### Twelfth Embodiment

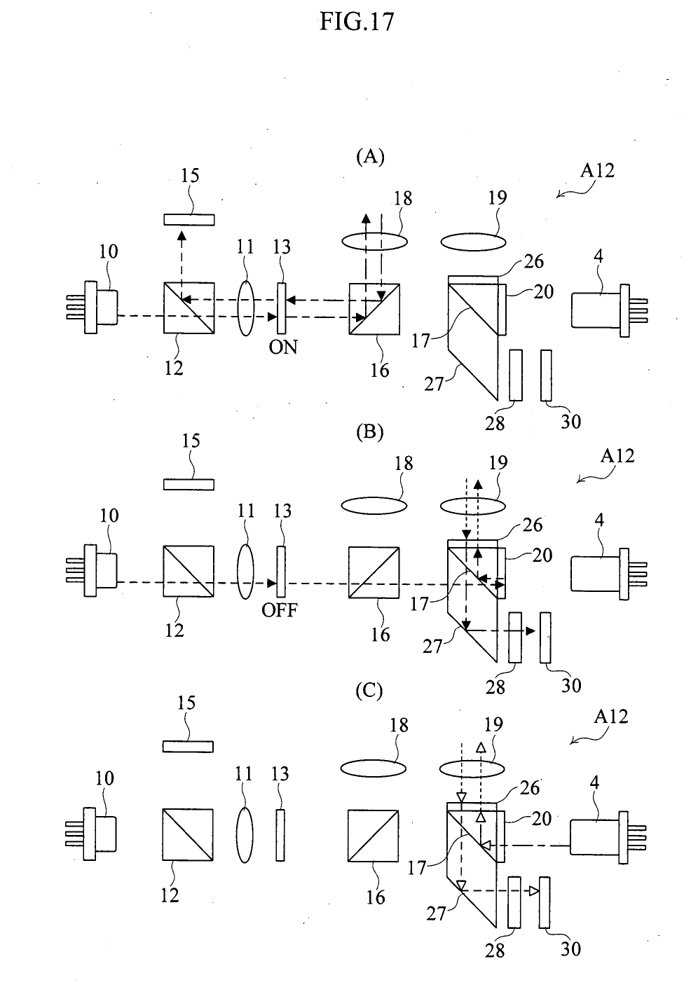

As shown in FIGS. 17(A) to 17(C), an optical pickup A12 according to this embodiment has a structure similar to that of the fifth and the ninth embodiment (Ref. FIGS. 9(A) to 9(C) and 14(A) to 14(C)). Specifically, in the optical pickup A12, only the dichroic mirror 20 is provided between the upward reflection mirror 17 and the laser unit 4, and between the second objective lens 19 and the upward reflection mirror 17 the λ/4 plate 26 is provided. The upward reflection mirror 17 is constituted of an ordinary half mirror. The dichroic mirror 20 has the characteristic of reflecting the blue laser beam, and transmitting the red laser beam.

In this embodiment also, as shown in FIG. 17(A), for the recording/reproduction with respect to the Blu-ray Disc, generally the same process as that described referring to FIGS. 9(A) and 14(A) may be performed.

As shown in FIG. 17(B), in the case of performing the recording/reproduction with respect to the HD-DVD, the blue P-polarized laser beam is transmitted through the surface of the upward reflection mirror 17. The blue laser beam transmitted through the mirror surface is reflected by the dichroic mirror 20, thus returning to the surface of the upward reflection mirror 17.

Further, the blue laser beam is reflected by the surface of the upward reflection mirror 17, so as to proceed to the second objective lens 19 through the λ/4 plate 26. In this process, the blue P-polarized laser beam is converted by the λ/4 plate 26 from the linearly polarized light into the circularly polarized light. Accordingly, the HD-DVD is irradiated with the circularly polarized laser beam, through the second objective lens 19.

The circularly polarized laser beam illuminating the HD-DVD is reflected by the recording layer of the HD-DVD, to thereby return to the upward reflection mirror 17 through the second objective lens 19 and the λ/4 plate 26. In this process, the circularly polarized laser beam is converted by the λ/4 plate 26 from the circularly polarized light to the linearly polarized light. Thus, the laser beam illuminating the HD-DVD passes through the λ/4 plate 26 twice in both directions, to be thereby subjected to the phase shift of 180 degrees, and resultantly turns into the blue S-polarized laser beam and returns to the upward reflection mirror 17.

Accordingly, the S-polarized laser beam which has returned to the upward reflection mirror 17 is transmitted therethrough and reflected by the fixed mirror 27, after which the second photodetector 30 detects the blue S-polarized laser beam via the optical lens 28.

Under such configuration also, the second photodetector 30 and the first photodetector 15 are individually provided for the HD-DVD and the Blu-ray Disc respectively, which allows utilizing the appropriate photodetector for each optical disc, and enables precisely making optical access to the HD-DVD and the Blu-ray Disc.

As shown in FIG. 17(C), in the case of performing the recording/reproduction with respect to the CD/DVD, the second light source of the laser unit 4 emits, for example, the red S-polarized laser beam. The red laser beam is transmitted through the dichroic mirror 20 and reflected by the surface of the upward reflection mirror 17.

The red laser beam reflected by the surface of the upward reflection mirror 17 proceeds to the second objective lens 19 through the λ/4 plate 26. In this process, the red S-polarized laser beam is converted by the λ/4 plate 26 from the linearly polarized light into the circularly polarized light. Accordingly, the CD/DVD is also irradiated with the circularly polarized laser beam, through the second objective lens 19.

The circularly polarized red laser beam illuminating the CD/DVD is reflected by the recording layer of the CD/DVD, to thereby return to the upward reflection mirror 17 through the second objective lens 19 and the λ/4 plate 26. In this process, the red laser beam is converted by the λ/4 plate 26 from the circularly polarized light into the linearly polarized light. Thus, the red laser beam illuminating the CD/DVD passes through the λ/4 plate 26 twice in both directions, to be thereby subjected to the phase shift of 180 degrees, and resultantly turns into the red P-polarized laser beam and returns to the upward reflection mirror 17.

The P-polarized laser beam which has returned to the upward reflection mirror 17 is transmitted therethrough and reflected by the fixed mirror 27, after which the second photodetector 30 detects the red P-polarized laser beam via the optical lens 28.

Therefore, the optical pickup A12 according to this embodiment also provides the similar advantageous effects to those offered by, for example, the ninth embodiment, and further allows utilizing the second photodetector 30 for both the HD/DVD and the CD/DVD, thereby increasing the commonality of the optical components to a higher level.

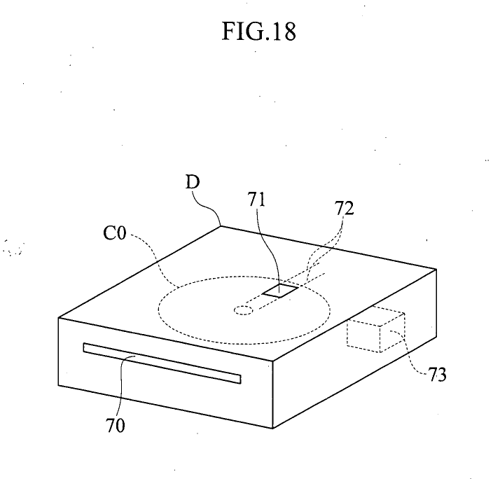

As shown in FIG. 18, one of the optical pickups A1 to A12 (not shown in FIG. 18) according to the first to the twelfth embodiments may be provided in an optical disc device D. The optical disc device D includes an insertion slot 70 through which an optical disc C0 is inserted, a traverse unit 71 on which one of the optical pickups A1 to A12 is mounted, a guide rail 72 supporting the traverse unit 71 so as to reciprocate radially of the optical disc C0, and a driving unit 74 that reciprocatively moves the traverse unit 71 along the guide rail 72. The optical disc device D can reduce the thickness and dimensions of the device as a whole, by incorporating one of the optical pickups A1 to A12. Here, although this embodiment represents the case where the optical pickup 1 according to the first embodiment is mounted on the optical disc device 7, naturally the optical pickup A1 may be substituted with the optical pickups according to any of the second to the fifth embodiments.

It is to be noted that the present invention is not limited to the foregoing embodiments.

For example, the first objective lens may be utilized for the HD-DVD, and the second objective lens may be utilized for the Blu-ray Disc.

1. An optical pickup including a first objective lens and a second objective lens, comprising:
a first light source for emitting a laser beam of a predetermined wavelength;
a polarizing beam splitter for dividing the laser beam into a first polarized beam having a predetermined polarization characteristic to be reflected to the first objective lens and a second polarized beam having a different polarization characteristic to be transmitted to the second objective lens; and
a polarization control element located between the first light source and the polarizing beam splitter for converting the laser beam emitted by the first light source into the first polarized beam and the second polarized beam.

2. The optical pickup according to claim 1, further comprising an upward reflection mirror located immediately under the second objective lens, wherein the polarizing beam splitter is located immediately under the first objective lens, the mirror being arranged to direct the second polarized beam transmitted through the polarizing beam splitter toward the second objective lens.

3. The optical pickup according to claim 2, further comprising:
a second light source for emitting a laser beam different in wavelength from the first light source; and
a dichroic mirror for reflecting one of the laser beams emitted by the first light source and the second light source, and for transmitting the other of the laser beams;
wherein the upward reflection mirror is constituted of a half mirror, and the dichroic mirror is located between the second light source and the upward reflection mirror, or between the polarizing beam splitter and the upward reflection mirror.

4. The optical pickup according to claim 3, wherein the laser beam emitted by the first light source to be incident upon the polarizing beam splitter and the laser beam emitted by the second light source to be incident upon the upward reflection mirror are on an approximately same optical axis, but incident from opposite directions.

5. The optical pickup according to any one of claims 2-4, further comprising:
an intermediate half mirror located between the first light source and the polarization control element;
a first photodetector for detecting, via the intermediate half mirror, the laser beam returning from at least one of the first objective lens and the second objective lens through the polarizing beam splitter and the polarization control element; and
a collimator lense provided at two positions, one between the first light source and the intermediate half mirror and the other between the intermediate half mirror and the first photodetector, or provided at one position between the intermediate half mirror and the polarization control element.

6. The optical pickup according to claim 5, further comprising:
a λ/4 plate located between the polarizing beam splitter and the first objective lens; and
a second photodetector for detecting the laser beam that has passed through the λ/4 plate twice in both directions thereby returning from the first objective lens through the polarizing beam splitter in a different direction from the first photodetector;
wherein the first photodetector detects the laser beam returning from the second objective lens through the upward reflection mirror.

7. The optical pickup according to claim 3 or 4, further comprising:
an intermediate half mirror located between the first light source and the polarization control element;
a first photodetector for detecting, via the intermediate half mirror, the laser beam returning from at least one of the first objective lens and the second objective lens through the polarizing beam splitter and the polarization control element; and
a first collimator lense located between the first light source and the intermediate half mirror;
a second collimator lense located between the intermediate half mirror and the first photodetector;
wherein a λ/4 plate for a specific wavelength band corresponding to the first light source, the dichroic mirror, and a phase correction plate corresponding to the second light source are sequentially aligned in a direction from the upward reflection mirror to the second light source and in a region therebetween,
wherein the upward reflection mirror is constituted of a polarizing half mirror, and the dichroic mirror reflects the laser beam emitted by the first light source and transmits the laser beam emitted by the second light source.

8. The optical pickup according to claim 3 or 4, further comprising:
an intermediate half mirror located between the first light source and the polarization control element;
a first photodetector for detecting, via the intermediate half mirror, the laser beam returning from at least one of the first objective lens and the second objective lens through the polarizing beam splitter and the polarization control element; and
a collimator lense located between the intermediate half mirror and the polarization control element;
wherein a λ/4 plate for a specific wavelength band corresponding to the first light source, the dichroic mirror, and a phase correction plate corresponding to the second light source are sequentially aligned in a direction from the upward reflection mirror to the second light source and in a region therebetween,
wherein the upward reflection mirror is constituted of a polarizing half mirror, and the dichroic mirror reflects the laser beam emitted by the first light source and transmits the laser beam emitted by the second light source.

9. The optical pickup according to claim 7, wherein the first photodetector detects the laser beam returning from the first objective lens through the polarizing beam splitter, and the upward reflection mirror is constituted of a polarizing half mirror; the optical pickup further comprising:
a λ/4 plate located between the upward reflection mirror and the second objective lens; and
a second photodetector that detects the laser beam that has passed through the λ/4 plate twice in both directions thereby returning from the second objective lens through the upward reflection mirror in a different direction from the first photodetector.

10. The optical pickup according to claim 3 or 4, wherein the upward reflection mirror is constituted of a polarizing half mirror, and the dichroic mirror reflects the laser beam of the predetermined wavelength emitted by the first light source and transmits the laser beam of the different wavelength emitted by the second light source; the optical pickup further comprising:
two λ/4 plates respectively located between the polarizing beam splitter and the first objective lens and between the upward reflection mirror and the second objective lens;
a first photodetector that detects the laser beam that has passed through the λ/4 plate twice in both directions thereby returning from the first objective lens through the polarizing beam splitter in a different direction from the first light source;
two collimator lenses located between the first light source and the polarizing beam splitter and between the polarizing beam splitter and the first photodetector; and
a second photodetector that detects the laser beam that has passed through the λ/4 plate twice in both directions thereby returning from the second objective lens through the upward reflection mirror in a different direction from the second light source;
wherein the λ/4 plate for the specific wavelength band corresponding to the first light source, the dichroic mirror, and the phase correction plate corresponding to the second light source are sequentially aligned in a direction from the upward reflection mirror to the second light source and in a region therebetween.

11. The optical pickup according to claim 3 or 4, further comprising:
an intermediate half mirror located between the first light source and the polarization control element;
a first photodetector that detects, via the intermediate half mirror, the laser beam returning from both of the first objective lens and the second objective lens through the polarizing beam splitter and the polarization control element; and
a collimator lense provided at two positions, one between the first light source and the intermediate half mirror and the other between the intermediate half mirror and the first photodetector, or provided at one position between the intermediate half mirror and the polarization control element;
wherein a λ/2 plate and the dichroic mirror are sequentially aligned in a direction from the polarizing beam splitter to the upward reflection mirror and in a region therebetween,
wherein the dichroic mirror transmits the laser beam of the predetermined wavelength emitted by the first light source and may reflect the laser beam of the different wavelength emitted by the second light source.

12. The optical pickup according to claim 11, wherein the λ/4 plate is located between the dichroic mirror and the upward reflection mirror.

13. The optical pickup according to claim 3 or 4, wherein the upward reflection mirror is constituted of a polarizing half mirror, and the dichroic mirror is located between the second light source and the upward reflection mirror so as to reflect the laser beam of the predetermined wavelength emitted by the first light source and transmit the laser beam of the different wavelength emitted by the second light source, the optical pickup further comprising:
an intermediate half mirror located between the first light source and the polarization control element;
a first photodetector for detecting, via the intermediate half mirror, the laser beam returning from the first objective lens through the polarizing beam splitter and the polarization control element;
a first collimator lense located between the first light source and the intermediate half mirror;
a second collimator lense located between the intermediate half mirror and the first photodetector;
a λ/4 plate located between the upward reflection mirror and the second objective lens; and
a second photodetector for detecting the laser beam that has passed through the λ/4 plate twice in both directions thereby returning from the second objective lens through the upward reflection mirror in a direction different from the first light source.

14. The optical pickup according to claim 3 or 4, wherein the upward reflection mirror is constituted of a polarizing half mirror, and the dichroic mirror is located between the second light source and the upward reflection mirror so as to reflect the laser beam of the predetermined wavelength emitted by the first light source and transmit the laser beam of the different wavelength emitted by the second light source, the optical pickup further comprising:
an intermediate half mirror located between the first light source and the polarization control element;
a first photodetector for detecting, via the intermediate half mirror, the laser beam returning from the first objective lens through the polarizing beam splitter and the polarization control element;
a collimator lense located between the intermediate half mirror and the polarization control element;
a λ/4 plate located between the upward reflection mirror and the second objective lens; and
a second photodetector for detecting the laser beam that has passed through the λ/4 plate twice in both directions thereby returning from the second objective lens through the upward reflection mirror in a direction different from the first light source.

15. The optical pickup according to any one of claims 1-4, wherein one of the first objective lens and the second objective lens is compatible with a Blu-ray Disc, and the other with a HD-DVD.

16. The optical pickup according to claim 15, wherein the first light source is a blue laser source for emitting the laser beam of approximately 405 nm in wavelength.

17. The optical pickup according to claim 15, wherein the second objective lens is compatible with a plurality of types of discs of a standard different from that of the Blu-ray Disc and the HD-DVD.

18. An optical disc device, comprising the optical pickup according to any one of claims 1-4.
